(19) United States
(12) Patent Application Publication
(10) Pub. No.: US 2025/0217401 A1
(43) Pub. Date: Jul. 3, 2025

(54) COGNITIVE MODEL FOR FORM PROCESSING

(71) Applicant: Zoho Corporation Private Limited, Chengalpattu Taluk (IN)

(72) Inventors: Manikanda Vignesh Soundararajan, Salem (IN); Balachandar S, Chengalpet (IN); Ramprakash Ramamoorthy, Chengalpet (IN); Shailesh Kumar Davey, Potheri (IN); Subathra Periakaruppan, Madurai (IN)

(21) Appl. No.: 19/002,356

(22) Filed: Dec. 26, 2024

Related U.S. Application Data
(60) Provisional application No. 63/555,233, filed on Feb. 19, 2024.

(30) Foreign Application Priority Data
Dec. 29, 2023 (IN) 202341089907

(51) Int. Cl. G06F 16/355; G06F 40/166; G06V 30/412

(52) U.S. Cl. CPC G06F 16/355; G06F 40/166; G06V 30/412

(57) ABSTRACT

Systems and methods for a Form Recognizer Model to extract Name-Value pairs automatically and classify the form using the name-value pairs are described. The Name-Value pairs are extracted by identifying Explicit Names and Implicit Names from the pre-processed form. The tables in the form are also extracted. A Dynamic Relationship Builder assists in finding the classification of any unknown form that is fed to the Form Recognizer Model. The proposed model can provide three-fold functionalities, such as digitizing a scanned form into a readable and editable format that can also be stored; identifying the classification of the scanned form; and recommending a list of Name-Value Pairs, Tables and their associated Compositions for designers who would like to design a new form.

### CROSS REFERENCE TO RELATED APPLICATIONS

This application claims priority to U.S. Provisional Patent Application Ser. No. 63/555, filed Feb. 19, 2024 and Indian Provisional Patent Application No. 202341089907filed Dec. 29, 2023, each of which is incorporated by reference herein.

### BACKGROUND

Forms serve as a tool in collecting information for a particular application or for a specific use. The collected information in form needs to be analyzed and stored whereby it can be used for future processing.

### BRIEF DESCRIPTION OF DRAWINGS

FIG. 1. Structure of a form.

FIG. 2. Invoice Form Depicting Source Address and Target Address.

FIG. 3. Illustration of different types of forms based on the weightage of data inside forms.

FIG. 4. Overall Architecture of a Form Recognizer Model.

FIG. 5. Form Digitization Phase.

FIG. 6. Image Pre-processing.

FIG. 7. Stages of Clustering in a scanned form to identify the clusters based on Visual Density Clustering.

FIG. 8. Items are associated with their spatially closest Composition IDs.

FIG. 9. Extracted Text stored in same cell or different cells based on Mode Gap.

FIG. 10. Cell Correction places an Item with a Separator in Two Different Cells.

FIG. 11. Cell Correction retains a Date content in a single cell with separators in the same cell.

FIG. 12. Cell Correction in Form Digitization Phase.

FIG. 13. Separator Analysis in Cell Correction of Form Digitization Phase.

FIG. 14. Form Recognition Phase.

FIG. 15. Name-Value Pair Identification (Explicit Name-Value Pairs).

FIG. 16. Composition of an Instance of an Implicit Name Variable.

FIG. 17A and FIG. 17B. Sample Implicit Name-Value Repository.

FIG. 18. Name-Value Pair Identification (Implicit Name-Value Pairs).

FIG. 19. Identification of Implicit Names associated with the Values present in a Form.

FIG. 20. Restaurant Receipt depicting clustering done on the table elements.

FIG. 21A. Table Identification (Decide Progression).

FIG. 21B. Table Identification (Union Behavior Verification).

FIG. 22. Form showing an Independent Value.

FIG. 23. Name-Value Identification (Independent Values) using Whole Form Analysis.

FIG. 24. Dynamic Relationship Builder.

FIG. 25. Relationship Calculator.

FIG. 26. Strong and Weak relationship of Name-Value pairs in Source and Target to the Form Type “Invoice”.

FIG. 27. Strong and Weak relationship of Name-Value pairs in Source and Target to the Form Type “Identity/Authorization Cards”.

FIG. 28. Form Design Recommendation Module.

FIG. 29. Form Recognition System.

### DETAILED DESCRIPTION

Form Recognizer is an automated data processor system that utilizes preprocessing techniques and OCR engine to extract the text and data from a form. A form is a document that contains filled in data fields or items. An item can be a name (e.g., identifier), a value, or a Name-Value pair. A group or combination of items are called compositions. These compositions are framed based on the proximity of the items with one another. These compositions highly influence the classification of a form.

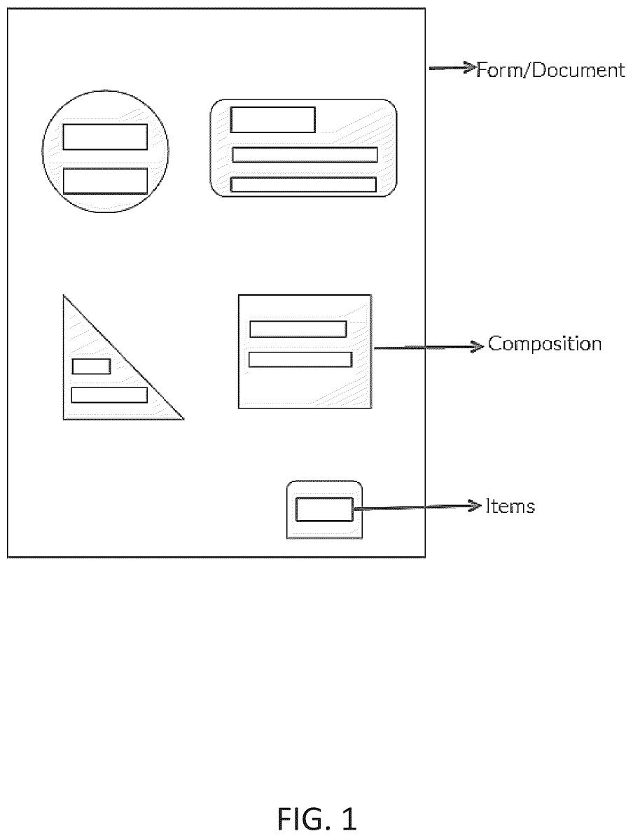

Each form has a form structure or design depending on the ways the items and compositions are presented. These aspects are taken into consideration while designing the proposed Form Recognizer Model. FIG. 1 shows the structural composition of a form.

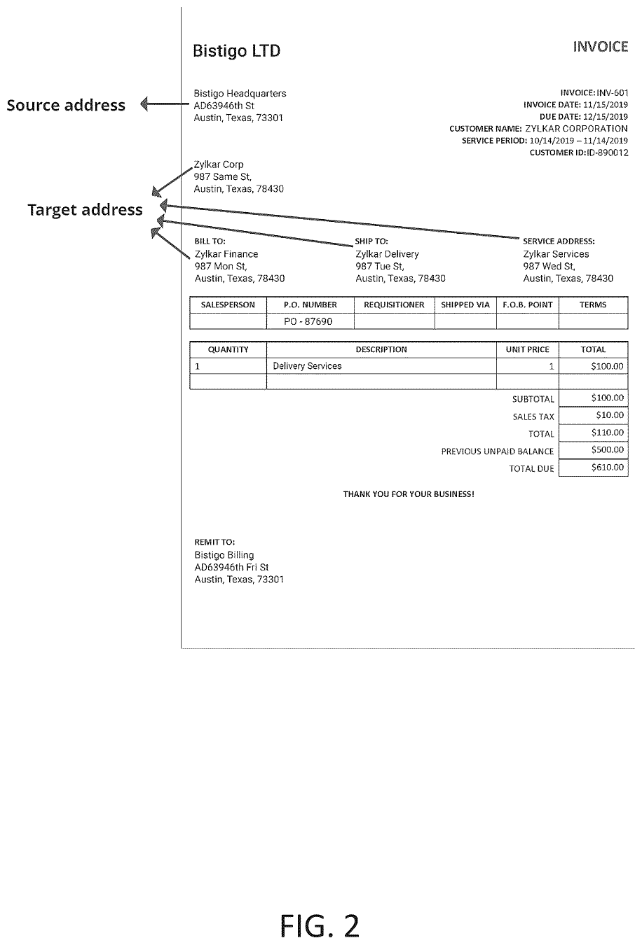

A form is a tool indicating an exchange action that happens between two groups: Source and Target. A source is an entity that is responsible for issuing that form. A target is an entity for whom the form is intended. For instance, in the case of a business or visiting card, the entity that prints and delivers the visiting card is the source and the entity that obtains the card from the source is a target. For instance, in case of ID cards issued by any authority or organization, the organization will be the source, and the employee will be the target. FIG. 2 is an example of an invoice form where the source and target addresses are available in distinguishing positions. Some of the target addresses have labels such as BILL TO, SHIP TO and SERVICE ADDRESS to identify them while the source address and a one other target address do not have such labeling. The challenge of the Form Recognizer Model is to identify such entities as either a source or a target.

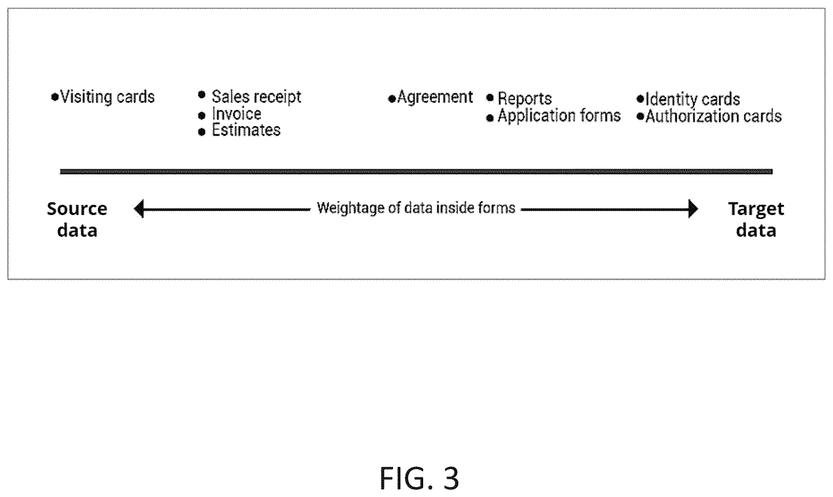

There is a serious relationship between the net amount of data present in a form about the “Source” and “Target” and the “Form Type”. FIG. 3 gives an illustration of different types of forms based on the weightage of data present in the forms. It could be observed that a visiting card has more of “Source” data than an Identity card which is highly populated with the “Target” data.

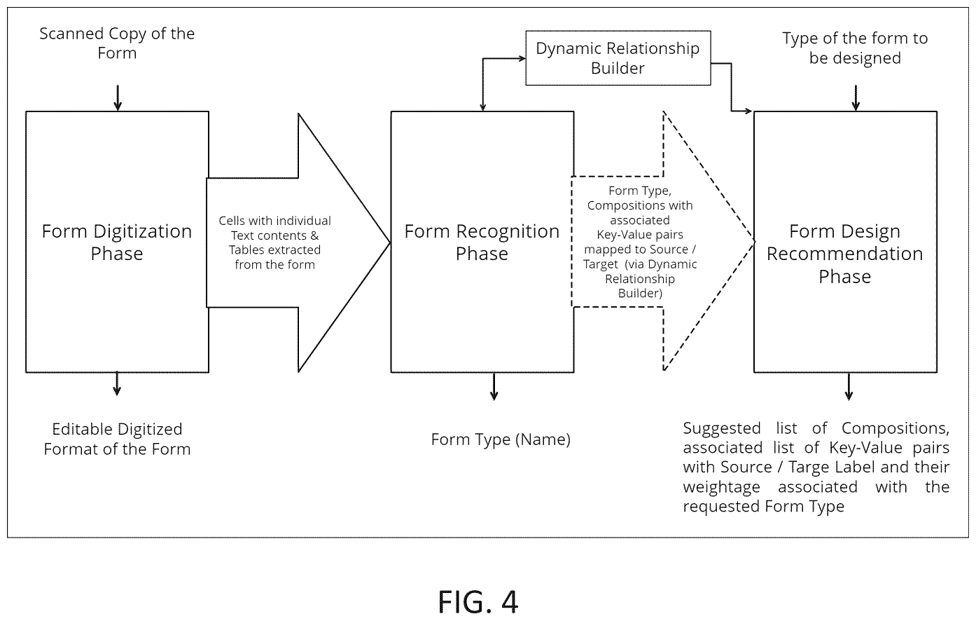

With this background features on the forms, the overall architecture of the proposed Form Recognizer Model is depicted in FIG. 4. The overall architecture in FIG. 4 shows three main phases: 1) Form Digitization Phase; 2) Form Recognition Phase; 3) Form Design Recommendation Phase.

A scanned copy of the form is given as an input to the Form Recognizer Model which is converted into a readable and editable digital format that can be stored in different cells maintaining the spatial positioning of the data values in the original form; the digital format of the form is also rendered to the user. Then the extracted cells of the form are passed on to a second phase, a Form Recognition Phase, where the digitized form is fed as an input and Form Type is determined by using Name-Value Pair analysis and table extraction from the form. These phases are supported by a Dynamic Relationship Builder that maintains a Form Classification Repository. Entities extracted from Form Classification form the input for a Form Design Recommendation Phase. These entities are fed through the Form Classification Repository present in the Dynamic Relationship Builder. When a user wants to design a form, the form classification/name is given as input to the Form Design Recommendation Phase of the Form Recognizer Model, which suggests a list of Name-Value pairs and their associated compositions to the user and the source/receiver label to the Name-Value pairs. These entities are rendered as a template to the user for choosing the required field for designing forms.

Based on the requirements, this proposal aims at three different outcomes, such as: 1) Given a scanned copy of a form, the text in the form is extracted and rendered in a format that is readable, editable and can also be stored without affecting the accuracy of the text content and the relative positioning of the text in the original form. 2) Given a scanned copy of a form, the Form Recognizer Model analyses the form and identifies the Type of the form like Voter ID Card, Driving license and so on. 3) Given a name of a form type to be designed for future use, the Form Recognizer suggests a list of Name-Value pairs in association with their Compositions. It also makes the best effort to label the Name-Value pairs as “Source” or “Target” and the relationship of this Name-Value pair with the form type as weakly associated, moderately associated or strongly associated.

A detailed description of each of the phases of operation and the process flow are given in the subsequent sections. Flow charts may be represented as modules and decision points presented by way of example. The order of modules and decision points can be reordered if appropriate. Reference numerals in the flowcharts for various figures may be presented parenthetically in the following description.

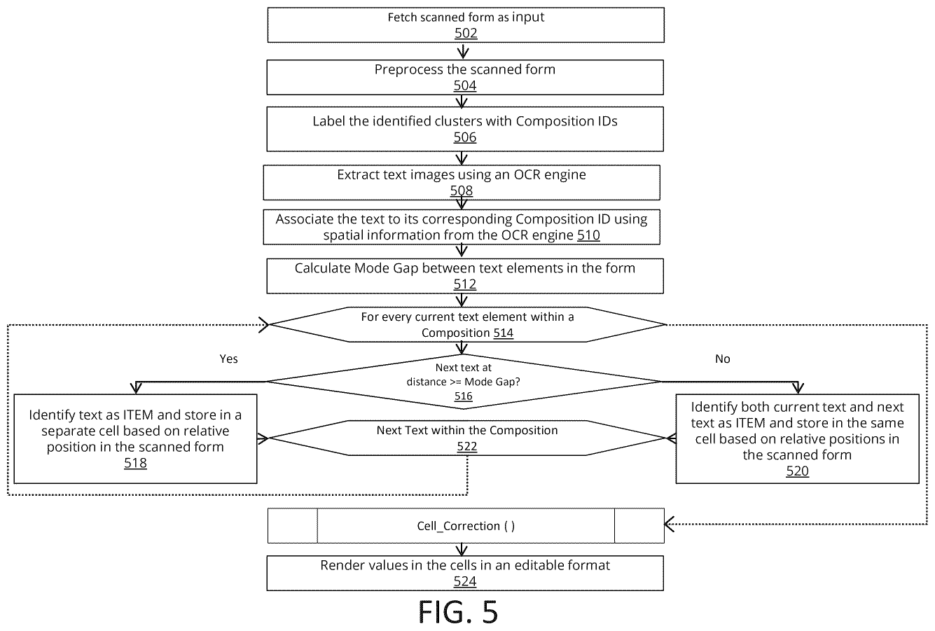

The hard copy of the form is fed to the Form Digitization phase and the sequence of processing done there is depicted in FIG. 5. The processing in this phase goes as follows.

The hard copy of the form is fetched as input and is scanned at module 502. This form is pre-processed which includes de-skewing, de-nosing, etc., at module 504. The form is then subjected to a clustering process where the text contents are clustered together based on Visual Density Clustering. The identified clusters are called “Compositions”, and these Compositions are given a unique ID, the Composition ID, at module 506. This scanned copy is fed to the OCR engine which extracts the text as image at module 508 and then converts them into their corresponding texts which are stored as individual “Items”. The centroid of the clusters/compositions are also fed to the OCR engine. The spatial positions of the Items are extracted from the OCR engine and based on the distance between these Items and the centroid of the Compositions, the Items are associated with the closest Composition IDs at module 510. Then a “Mode Gap” between the text contents (Items) in the entire form is calculated at module 512. The gap between the adjacent Items within each of the Compositions are identified and are compared with the Mode Gap at module 514 and decision point 516, Items that are placed at least at a distance of Mode Gap between them are placed in different Cells at module 518 (516-Yes) while that closer than that are placed in the same Cell at module 520 (516-No). Decision point 516 loops until there is no next text. Now to refine the data stored in the Cells, a Cell_Correction process is invoked, and the outcome of this Form Digitization process is the extracted text content from the input form is populated into separate Cells at module 524. These Cells are still associated with their corresponding Composition IDs and are available in a readable and editable format. These Cells are stored as individual fields in the final document.

Each of the following processes involved in the Form Digitization phase is elaborated in the subsequent sections. 1) Pre-Processing; 2) Item Extraction; 3) Cell Correction.

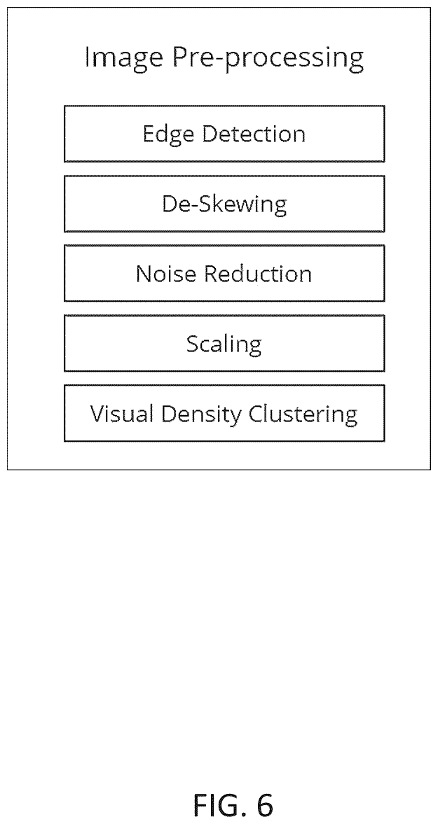

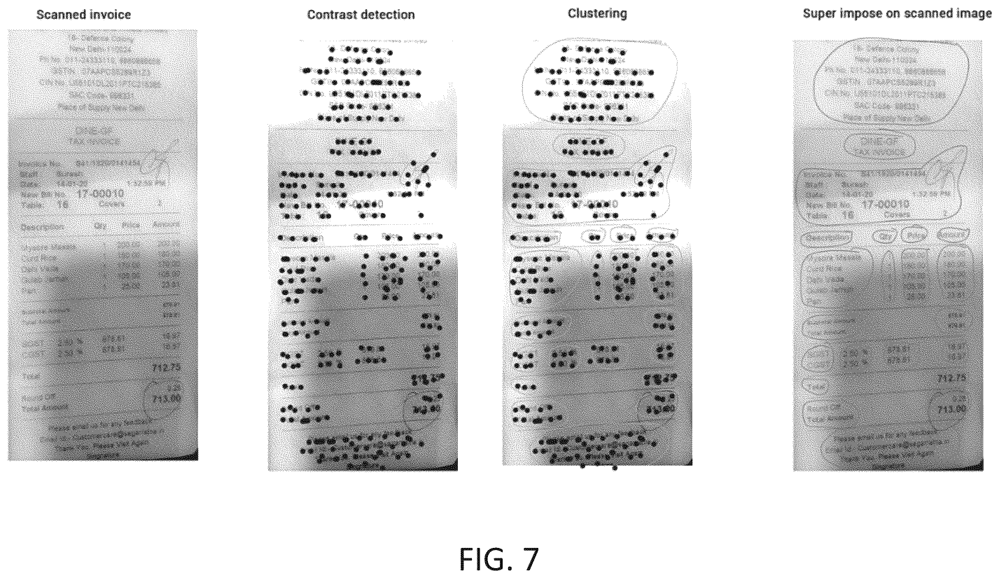

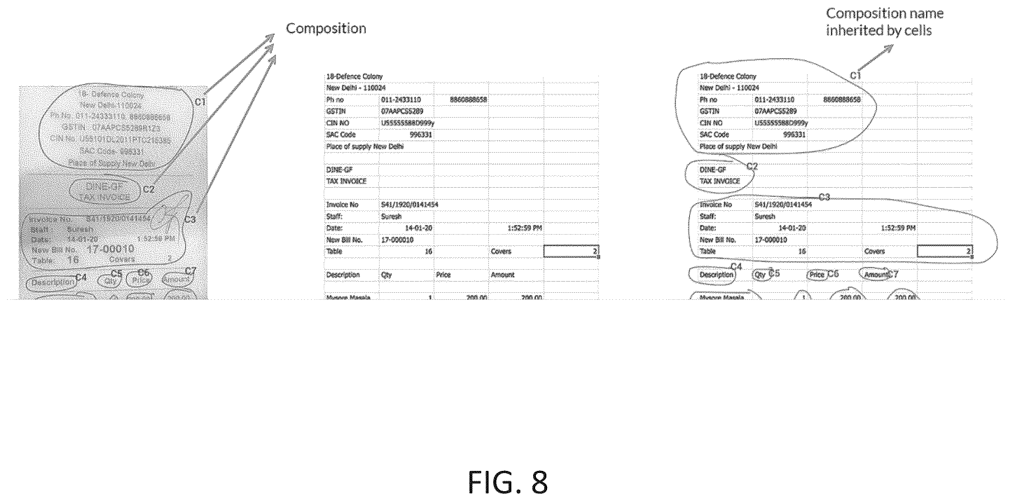

The processing involved in the pre-processing stage is depicted in FIG. 6. The scanned form undergoes a series of stages in pre-processing. Binarization where, the entire image is converted into monochrome black and white image. Here various shades of gray are converted into absolute black and white pixels. This simplifies the later processing by breaking down the image into just two colors. Noise reduction where, any pixel that exhibits a false information is removed off so that it does not affect further processing. De-skewing where, the scanned image is processed to get rid of any skewing. Scaling in the pre-processing of an image refers to the process of resizing the image to a different size as it allows for better handling and analysis of the image. The form is then subjected to clustering where the form is logically split into different clusters or compositions. Once the Compositions are identified, they are given a unique Composition ID and their proximity information to the neighboring Compositions are also stored in a graph. FIG. 7 depicts the various stages of Visual Density Clustering and FIG. 8 depicts the association of the Items with their closest composition and their corresponding Compositions IDs.

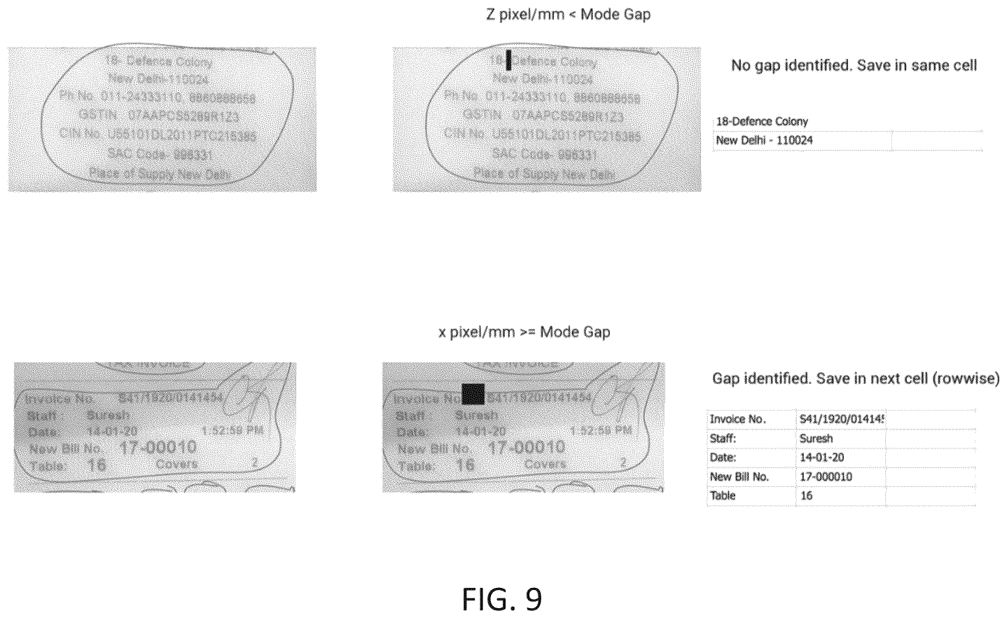

The form is then fed to the OCR engine which extracts the text contents from the form. The extracted text is called the “Item”. Each of the extracted items are stored in different cells. The gap between the adjacent Items within each of the Compositions are identified and are compared with the Mode Gap (the gap between two adjacent text elements that occurs the maximum number of times in the given form.), Items that are placed at least at a distance of Mode Gap between them are placed in different Cells while that closer than that are placed in the same Cell. The following FIG. 9 depicts two different scenarios where two items which are Z pixels or millimeters (mm) apart where, Z<Mode Gap are placed in the same cell and the items which are X pixels or millimeters (mm) apart where, X>=Mode Gap are placed in different cells that are horizontally adjacent to each other.

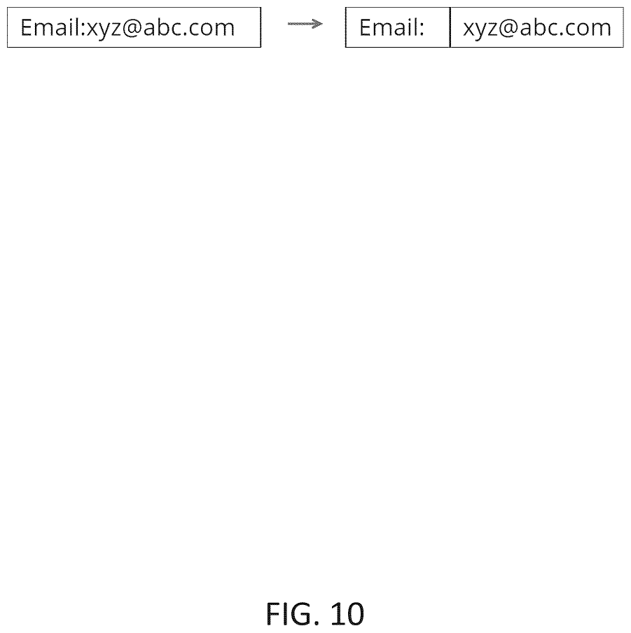

To refine the data stored in the Cells, a Cell_Correction process is invoked. The compositions in the identified images are analyzed and subjected to Cell_Correction process. The following scenarios depict the use of Cell_Correction. In FIG. 10, two items are placed inside the same cell since the gap between them is less than the Mode Gap. When this cell is subjected to Cell_Correction, the presence of a separator here, a colon is identified and the content in this single cell is split into two different cells.

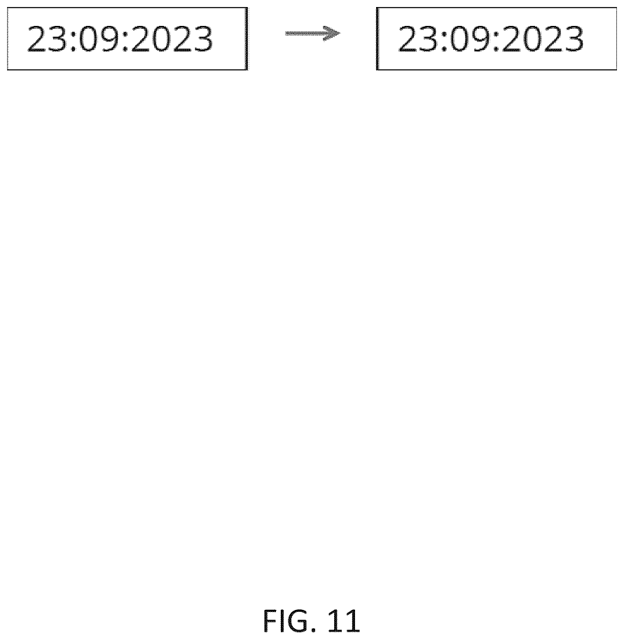

In FIG. 11, Cell_Correction retains a Date content in a single cell with separators in the same cell. However, since the cell content maps to a Date format, the content is considered as a text item representing date value and placed in the single cell irrespective of the presence of two colons in it.

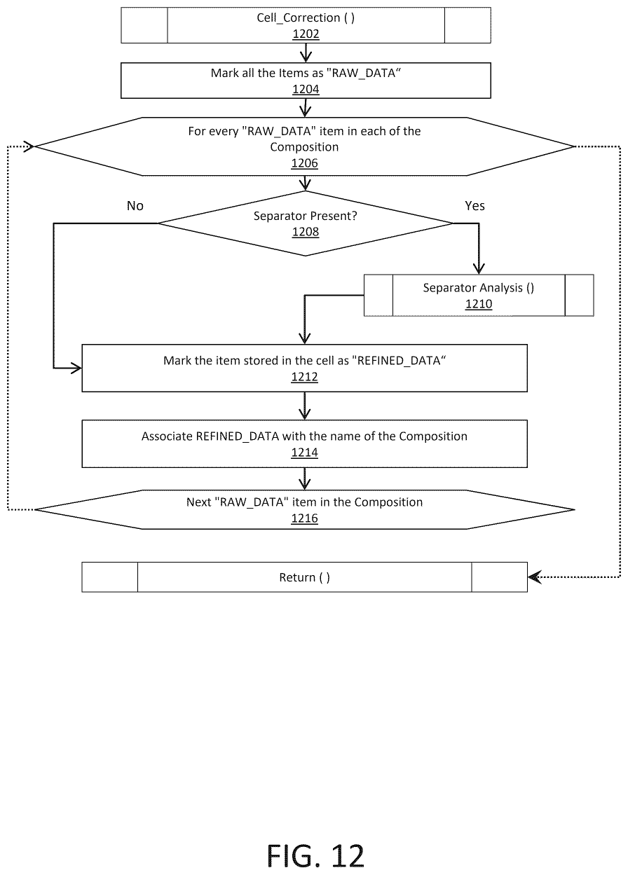

The process flow in cell correction is depicted in FIG. 12. In cell correction (1202), all the identified items are initially marked as “Raw_Data” (1204). For every “Raw_Data” item in the composition (1206, 1216), it is determined whether there is a separator present within the Item in a single cell (1208). A separator is a special character in between the Name and value. For instance, the Separator can be a {colon/semicolon/horizontal line/hyphen/colon hyphen combo}. If a separator is found (1206—Yes), then the separator analysis method is invoked (1210). If a separator is not found (1206—No), then that item in the cell is left unaltered. In either instance, the stored item is marked as “Refined_Data” (1212) and associated with the composition name within which the item is available (1214).

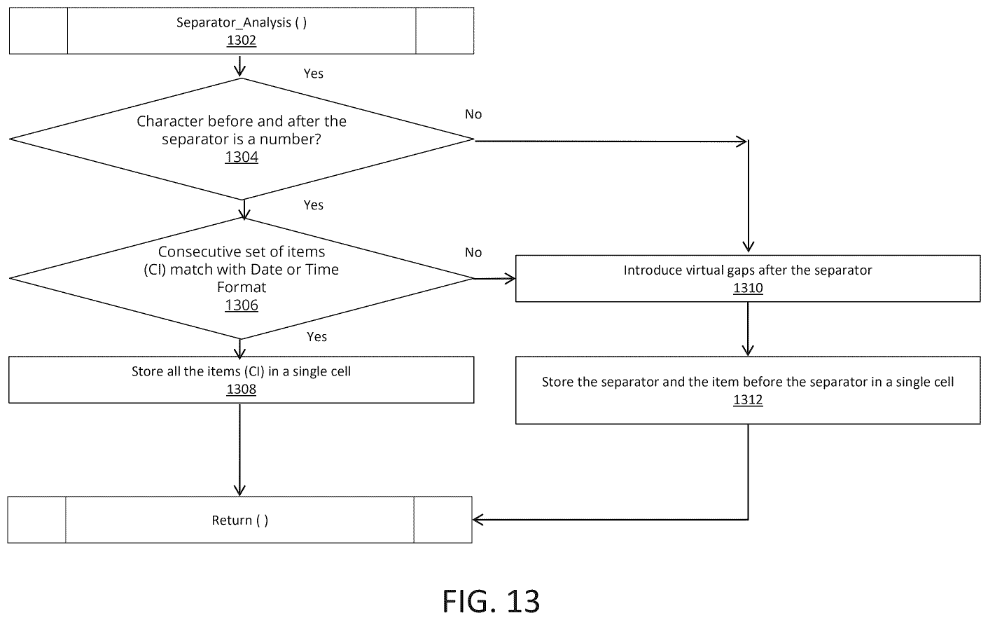

FIG. 13 depicts an example of separator analysis in cell correction of a form digitization phase. A Separator_Analysis function (1302), in the cell storage analysis, checks whether the character before and after the separator is a number (1304). If a number is found (1304—Yes), then the function checks whether the whole set of items matches with the date/time format (1306). An example Date format is 25:08:2023 (or) 2023/08/25. An example of Time format is 02:42:30. If a match is found then, the whole set of items is stored in a single cell (1308). Whereas, if the function does not find any Date/Time format, virtual gaps are introduced after the separator (1310) and the Items are stored in different cells (1312). By the end of this process, the text content in the form fed to this phase is converted into a Digital format which is readable and editable. It can also be stored as a text or a spreadsheet or an XML as required. This proposal uses the spreadsheet format for storage.

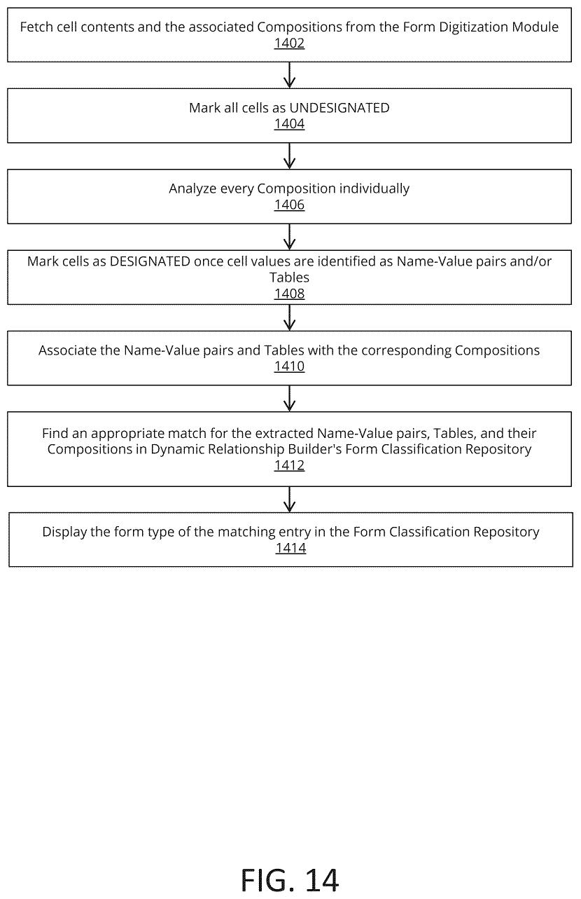

The proposed Form Recognizer Model can also identify the name of the form that is being fed to it. The input is the scanned copy of the form, which is digitized by the Form Digitization phase, then the extracted Digital document is fed to this Form Recognition phase which categorically identifies the form type as a Driving License or Voter ID or Invoice and so on. An example of a sequence of processing involved in the form recognition phase is depicted in FIG. 14.

The cell contents of the digitized form along with their association with the corresponding Composition IDs are received as input to this phase (1402). Initially all the Cells are marked as UNDESIGNATED (1404). Each of the Compositions are analyzed individually (1406) wherein the Name-Value pairs are identified and then based on the Union Behavior exhibited by the Name-Value pairs, Tables are identified in the form. Once cell values are identified as Attribute-Value pairs and/or Tables, corresponding cells are marked as DESIGNATED (1408). The Name-Value pairs and the Tables are associated with the corresponding Composition IDs (1410) and are sent to the Dynamic Relationship Builder for further processing. The Form Classification Repository in the Dynamic Relationship Builder is used to map the extracted Name-Value pairs and the Tables along with their associated Composition IDs and identify the type of the input form (1412). The Dynamic Relationship Builder is also able to identify different versions or templates of the same form and dynamically builds the Form Classification Repository as and when new Name-Value pairs or Tables or associating Composition IDs or combinations of all three parameters are encountered for the same form type. Optionally, the form type of a matching entry in the Form Classification Repository is then displayed (1414). Each of the processing involved in this Form Recognition Phase is elaborated in the following subsections.

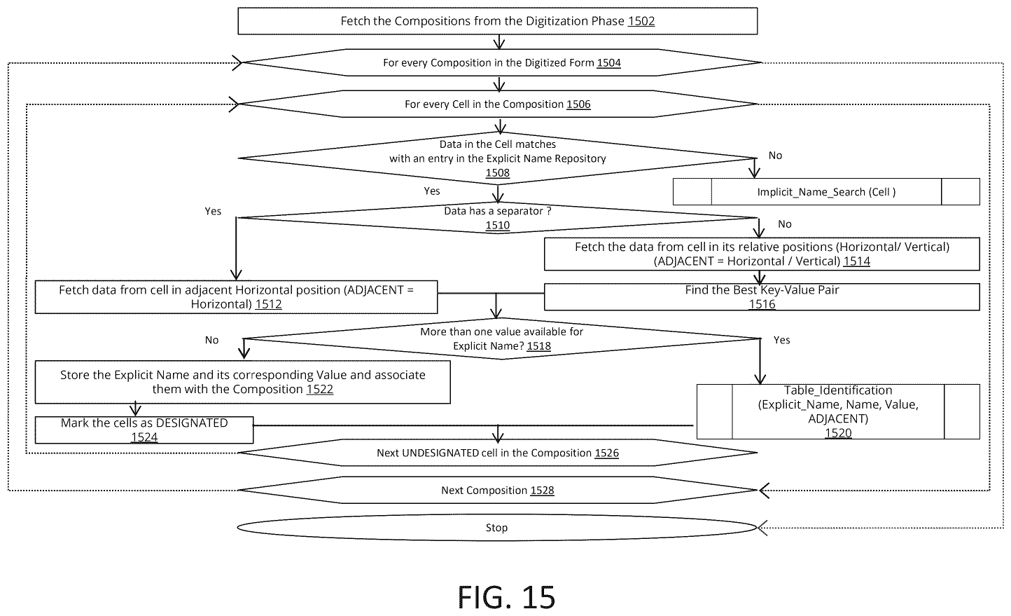

Name-Value pair identification forms the basis for this phase and the process flow is given in FIG. 15. For every composition fetched from the Digitization phase (1502) the Name-Value pair identification is carried out (1504, 1528). This process involves Identification of the Explicit Name-Value pairs; Identification of Implicit Name-Value pairs; Identification of Tables and Identification of Unknown Values.

The data value available in every Cell in the composition is fetched and analyzed (1506, 1526). The data in the Cell is compared with the entries in an Explicit Name Repository (1508). The Explicit Name Repository is a pre-built repository that comprises of the set of all Explicit Names and/or Values present in various forms such as Name of the person, Name of the Organization, Gender, Age, Address, Serial Number, Date, Time and so on. If the data value is present in the Explicit Name Repository (1508—Yes), then the presence of a separator like the colon or hyphen is verified (1510). Based on the presence of the separator (1510—Yes), the data in the cell in the horizontal direction adjacent to the cell being processed is considered to be the Value associated with the Explicit Name identified (1512). If a separator is not identified (1510—No) along with the Explicit Name, then the data values in the cells in both horizontal and vertical proximity is verified for the presence of a Value associated with the Explicit Name (1514). This is done using the Best-Fit method by comparing data in the cell content with that of the values in the Explicit Name Repository (1516).

Once a value is identified for the Explicit Name, verification is done for the presence of more than one such value associated with the same Explicit Name in the horizontal or vertical direction with respect to the Explicit Name in the form (1518). If more than one value is identified (1518—Yes), then the Table Identification method is invoked (1520) which identifies the Table present in the form. On the other hand, if the data in the Cell does not match with any entry in the Explicit Name Repository (1518—No), then the Implicit_Name_Search module is invoked which checks for the presence of the Implicit Name that could be associated with the data in the Cell being processed (1522). Once the Explicit and Implicit Name-Value pairs are identified, all the Cells processed are marked as DESIGNATED (1524).

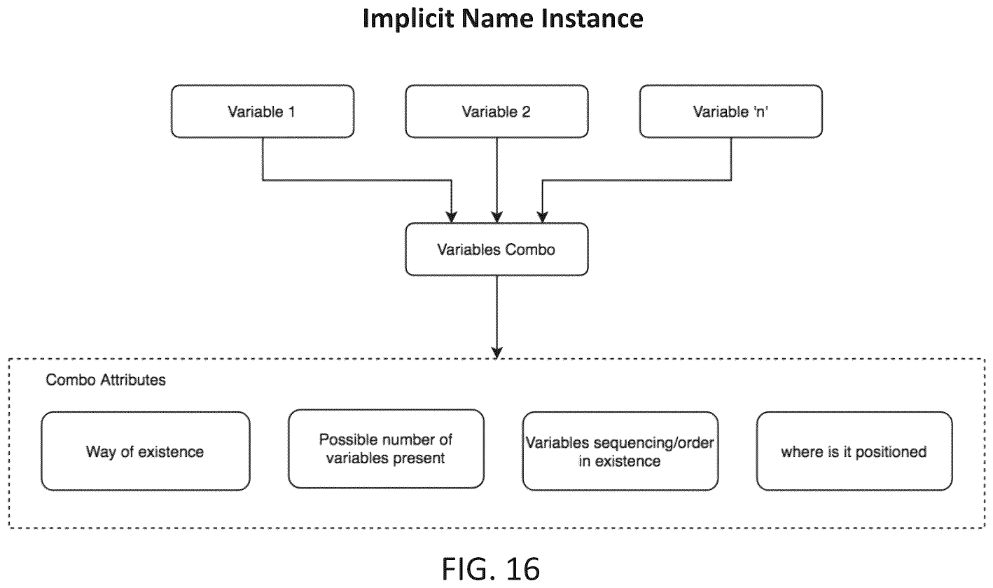

Implicit Names are those Names that are not explicitly mentioned in the form, but the value is available. Some of the Implicit Name are Address, Issue Number, Authority Signature and so on. The Implicit Name is identified with the help of an Implicit Name Repository. The Implicit Name can be associated with a single value like the Issue Number or multiple values like the Address. When it comes to multiple values being associated with a single implicit Name, an Implicit Name Instance is being defined as depicted by way of example in FIG. 16. A collection of values from adjacent Cells are combined based on various aspects like their way of existence, possible number of variables present, variable sequencing/order of existence and their positioning or proximity.

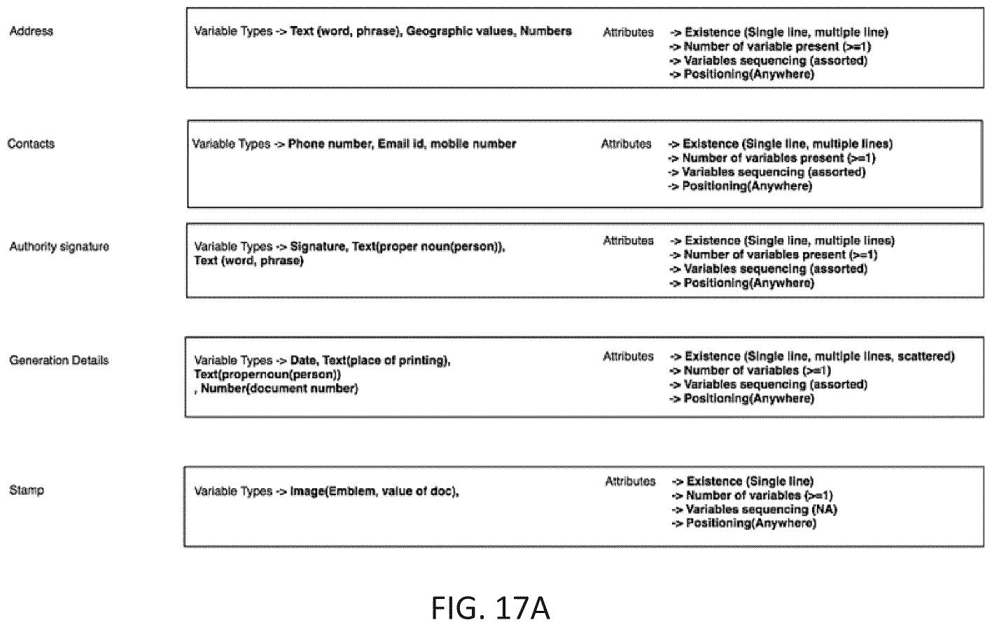

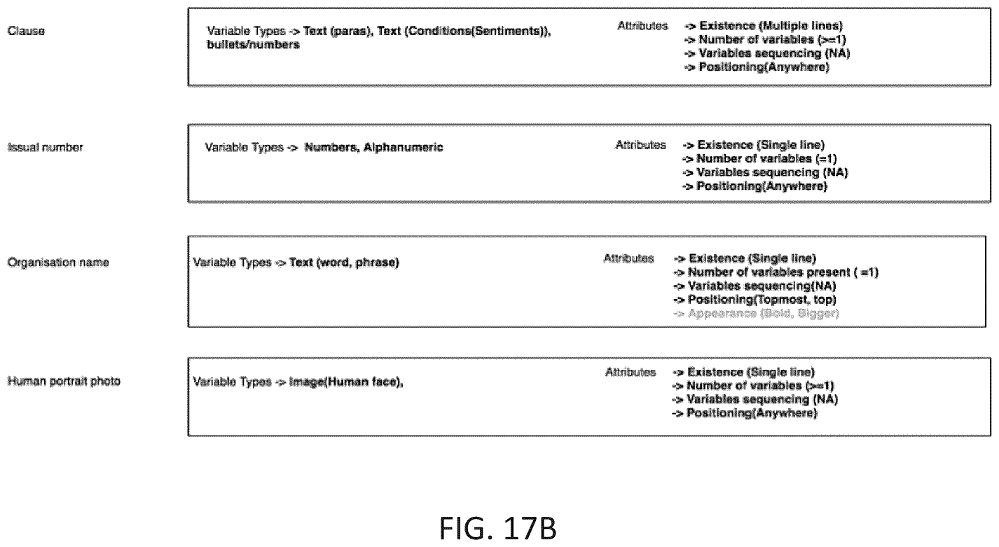

Based on the above definition, Values are collectively called under the umbrella of a single Implicit Name. An Implicit Name Repository as depicted by way of example in FIG. 17A and FIG. 17B are formulated by storing such Implicit Name instances defined.

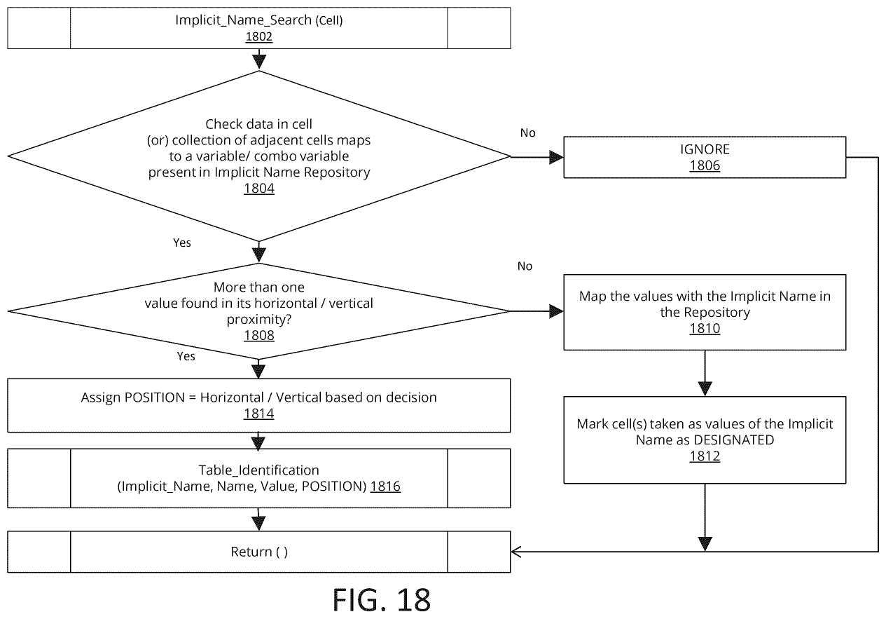

This Implicit Name Repository is used in the Implicit_Name_Search method (1802) depicted by way of example in FIG. 18. It checks if the data value in a single Cell or a collection of Cells in the horizontal or vertical proximity is available in the Implicit Name Repository (1804). If not (1804—No), ignore (1806). If present (1804—Yes) then it checks if more than one such value/value combo is available in its vertical/horizontal direction (1808). If no such values are available (1808—No), assign the Implicit Name as the Name to the value/value combo identified (1810) and mark cells taken as values of the Implicit Name as DESIGNATED (1812). If more than one such values/value combos are found (1808—Yes), then mark the POSITION of their existence as Horizontal or Vertical (1814) and invoke the Table Identification method (1816).

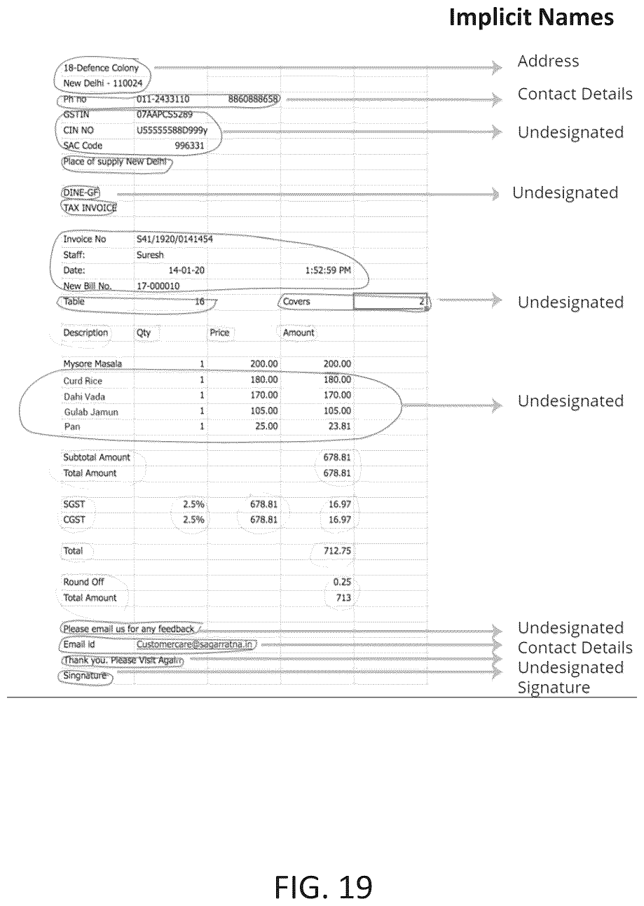

FIG. 19 depicts an example of a scenario where the Implicit Names for the values present in a form are identified. It can also be noticed that there are still few values that do not map with any of the existing templates in the Implicit Name Repository and hence remain UNDESIGNATED.

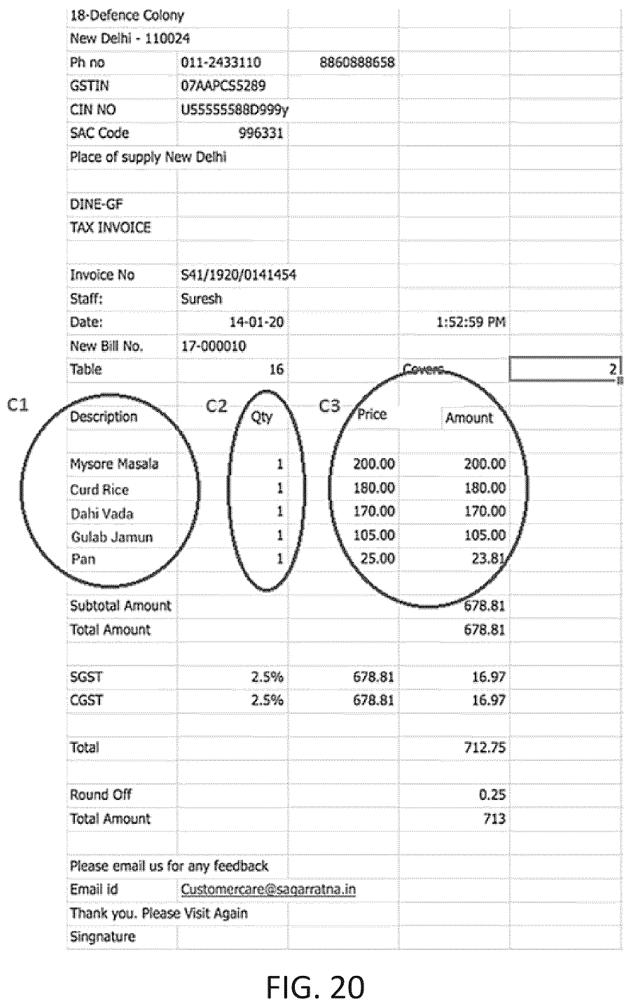

When multiple values are associated with a single Name, then there is a chance for an existence of a Table in the form. To handle this appropriately, a Table Identification Module is defined in this proposal. The Table Identification module initially processes the Composition where the Cell data is available and based on the requirement, it spans to the adjacent Compositions to fetch the columns/rows belonging to the same Table in the form (Column for row-based table and vice versa). This is implemented using Decide Progression and Union Behavior Verification process. The Decide Progression process identifies the values present in the same column/row that is associated with a single Name while the Union Behavior Verification process identifies the adjacent columns/rows of the same Table. The operation of the proposed Table Identification Module is explained below with an example in FIG. 20.

Consider the Restaurant Receipt shown in FIG. 20 for table extraction. For explanation, the table depicting the list of items, the quantity of each item, its price and the total amount is considered. When this form is subjected to clustering, let us assume that this table is clustered into three different compositions C1, C2 and C3 where composition C1 encloses a single column of the table with the caption “Description”, composition C2 encloses a single column with caption “Qty” (Quantity) and the third cluster C3 encloses two different columns with captions “Price” and “Amount”.

Now the composition C1 is processed when the first entry “Description” is an entry in the Explicit Name Repository and so a value associated with this in the horizontal/vertical position within the cluster C1 is searched for. This search identifies a value “Mysore Masala” in its vertical direction. Now that a single Name-Value pair is identified using the Explicit Name identification method, the Decide Progression algorithm is invoked to look for values similar to “Mysore Masala” (i.e., data that is neither an explicit Name nor an implicit Name) in the same composition in the direction of availability of the first value with respect to the implicit Name here, it is the vertical (down) position. During Decide Progression in vertical direction for the table shown in FIG. 20, text classification using NLP is done to ensure that all the values in the same column belong to same classification. Since similar values are identified in the same composition, indicating the presence of a column of a table, a counter is used to count the number of values associated with the caption “Description”. This Decide Progression here traces all 5 values in this column and stores it as a single column of the table.

Now, to identify the adjacent columns (if available) in the same table, the Union Behavior Verification is invoked which looks for the availability of the same number of values in the Horizontally adjacent direction to that of the identified values in column description of this table. This Union Behavior Verification Algorithm is carried out in the Horizontal direction in the same composition C1. Since no more values are available in C1, the search is extended to the horizontally adjacent composition C2 where 5 numeral values all identified in the vertically downward direction using the Decide Progression algorithm. Since the number of values in the first column in C1 is equal to that of the values in the new location, it is an indication that this is the next column of the same table. Now the Item type of this column is identified as the cell value vertically above the first value in this column and is verified with the Explicit Name Repository. It is to be noted that since the first column had a caption in the Explicit Name Repository, there are more chances for all the columns to have their captions as the first entry in the columns.

Now that the composition C2 is explored, the search continues to the composition C3 where two columns within the same cluster are identified one after the other using the Decide Progression algorithm to identify the elements of the same column and Union Behavior Verification algorithm to identify the adjacent column.

The Decide progression and Union Behavior Verification algorithms work in cohesion to extract a table that spans even across different compositions and renders and/or stores them in the format required. It is to be noted that in this row-based table where every row represents a unique record, the Decide Progression progresses in the vertical direction and the Union Behavior Verification proceeds in the horizontal direction. Thus, the Table identification procedure flips between the Decide Progression and Union Behavior Verification algorithm to extract the entire table which may span across multiple compositions. In a column-based table, the Decide progression will progress in the horizontal direction and the Union Behavior Verification in the vertical direction. Same procedure works when there are tables with no captions for the columns/rows. Here, the Implicit Name Repository is crosschecked to get the implicit Name that is to be associated as captions to these columns/rows and are stored. The output of the Table identification algorithm varies depending on the phase in which it is invoked. If invoked in the Form Digitization phase, the Strong Name captions are alone displayed and the Implicit Name captions are not displayed since the aim of this phase is just to convert the given form into a form that can be stored and/or edited. However, the Form Design Recommendation phase is invoked, the extracted and stored Implicit Name captions for the columns/rows of the table are listed in the suggestion parameters to the user who intends to design a form of the specified form type.

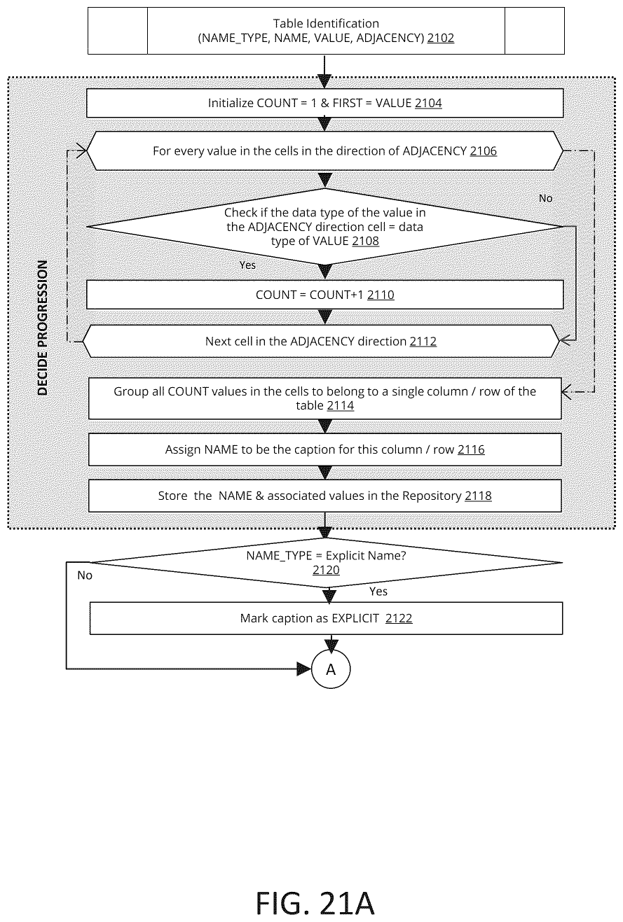

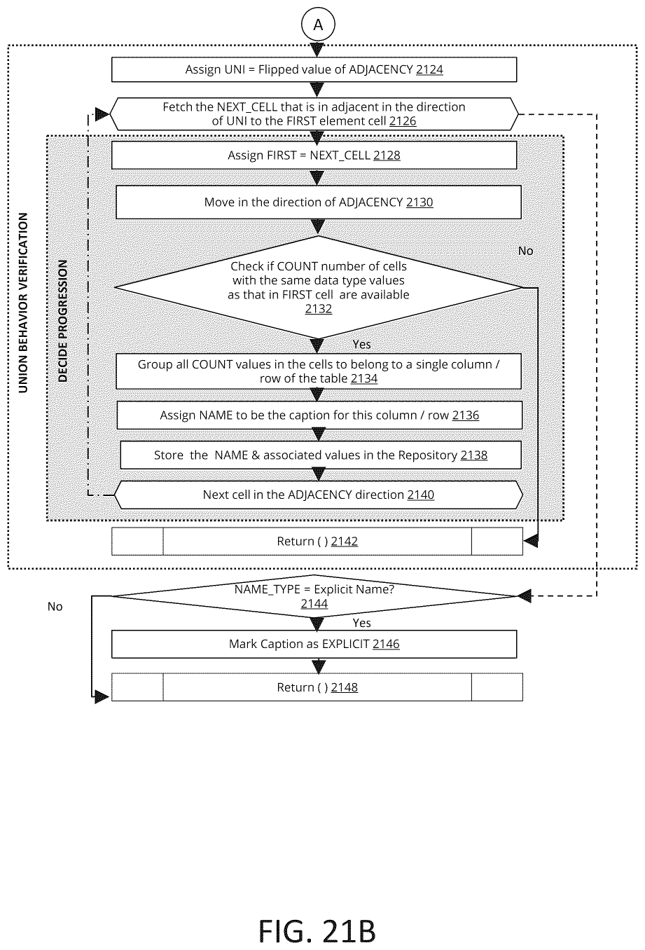

The sequence of steps involved in Table Identification method is shown in the FIGS. 21A and 21B. This method takes four parameters as input: Name_Type; Name; Value; Relative position of occurrence of multiple values as ADJACENCY variable (2102). The Name_Type indicates if the Name is an Explicit or Implicit Name.

The Decide Progression process keeps track of the number of similar values associated with the same Name (2104). The check for the similar values is done with the help of text classification methods using NLP. The Decide progression crawls one cell after the other in the direction described by the ADJACENCY variable (2106, 2110, 2112) to collect all the values that are of the same type (2108). All these values form the same column/row as decided by the ADJACENCY variable (2114). The caption for these values is the Explicit/Implicit Name taken as the input parameter (2116). The Name and associated values are stored in the Repository (2118).

Once all the values belonging to the same column/row as directed by the ADJACENCY variable using the Decide Progression are extracted and captions are marked EXPLICIT if indicated for Name Type (2120, 2122), the Table Identification method probes in the toggled direction to that mentioned in the ADJACENCY variable to check for the presence of adjacent columns/rows belonging to the same Table. To perform this search, the Table Identification method implements a Union Behavior Verification module that crawls to the adjacent column/row of the same or even to the neighboring Compositions (2124-2134, 2140, 2142, 2148). The Captions for the adjacent columns/rows are also decided based on the comparison of the first Cell data value with that of the Explicit Name Repository or the Implicit Name Repository (2136). Once all these Cells are processed and accepted as a part of the Table data. The process involved in the Union Behavior verification is depicted in FIG. 21B.

Decide Progression identifies the first column/row of a table, and the Union Behavior Verification tracks the other columns/rows of the same table which is in the same composition or the adjacent compositions. Thus, the Union Behavior Verification spans across adjacent compositions and is not restricted within a single composition. Once all the columns/rows of the table are identified, those with Explicit Names as Caption is marked as EXPLICIT while storing in the repository (2138, 2144, 2146). When the Table Identification algorithm is invoked in the Form Digitization phase, the Explicit Names are alone rendered as digital form to the user and the Implicit Name captions identified are not displayed. These implicit Name captions are however, rendered in the suggestion template to the user during the form design recommendation phase.

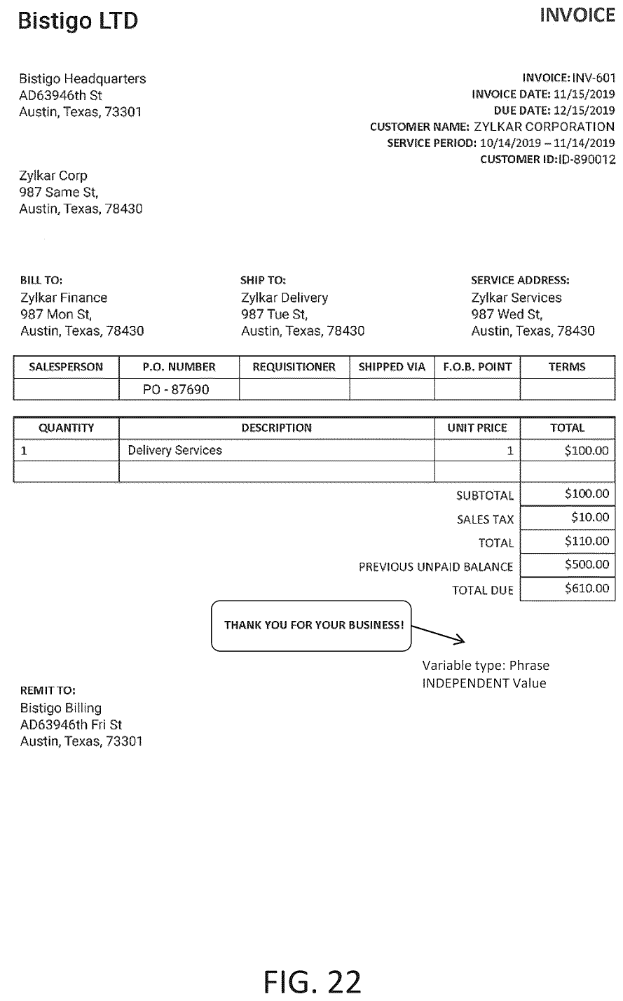

Even after the identification of the Explicit Name-Values, Implicit Name-Values and the Tables in the forms, there are possibilities for few of the Cells to be UNDESIGNATED still. These Cells are analyzed using a process called “Whole Form Analysis”. The UNDESIGNATED Cells from each of the Compositions are taken and compared with the DESIGNATED values in the adjacent Compositions. Here adjacency represents both the horizontal and vertical positions. If a match is found, then the UNDESIGNATED Cell values are associated with the Explicit/Implicit Name to which the adjacent Cell is mapped to and marked as DESIGNATED. If no such map is found this UNDESIGNATED Cell is labeled as an INDEPENDENT value and the Cell is marked DESIGNATED. INDEPENDENT values are those that do not have any Names associated with them but are available as simple values in the forms, e.g., “THANK YOU. VISIT AGAIN” is one such value present in shopping bills. FIG. 22 shows the Independent “THANK YOU. VISIT AGAIN” Value, which does not have any Explicit or Implicit Name associated with it.

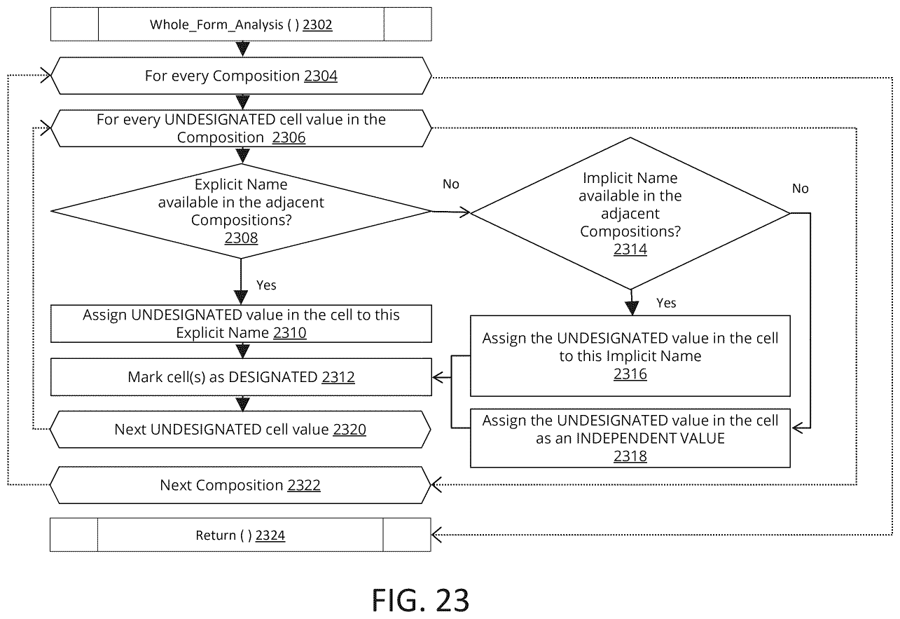

FIG. 23 depicts the process flow where an Independent Value is either mapped to an Explicit Name or Implicit Name using Whole Form Analysis and if such Name could not be identified, the values are marked as Independent Values. With Whole Form Analysis (2302), for every Composition (2304, 2322), for every UNDESIGNATED cell value in the Composition (2306, 2320), it is determined whether an Explicit Name is available in the adjacent Compositions (2308). If so (2308—Yes), an UNDESIGNATED value in the cell is assigned to the Explicit Name (2310) and the cell(s) are marked as DESIGNATED (2312). If not (1308—No), then it is determined whether an Implicit Name is available in adjacent Compositions (2314); if so (2314—Yes), then an UNDESIGNATED value in the cell is assigned to the Implicit Name (2316); if not (2314—No), an UNDESIGNATED value in the cell is assigned as an INDEPENDENT VALUE (2318); and in either case the flowchart continues to module 2312 as described previously.

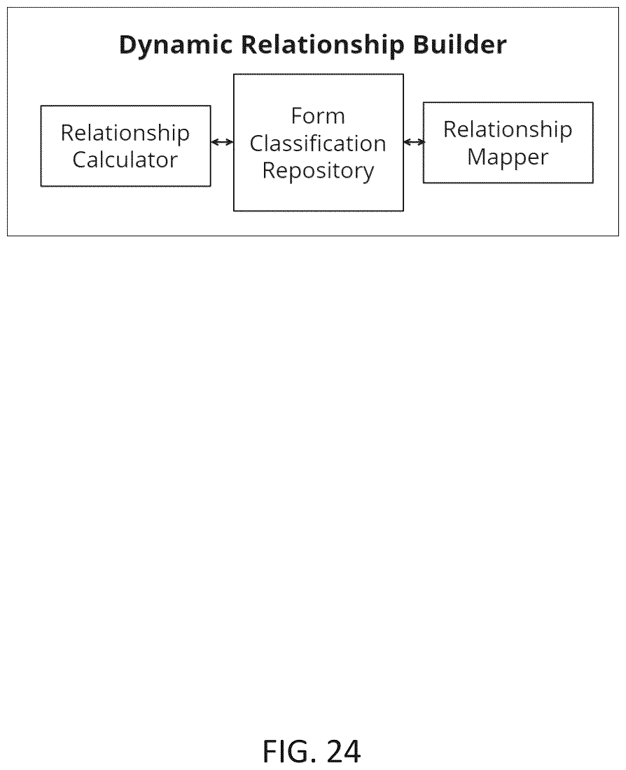

The Form Recognition Phase analyses the Cell data value and maps them as Explicit Name-Values or Implicit Name-Values, Tables or Independent values. These Name-Values are associated with the corresponding Composition IDs. The information gathered here is sent to the Dynamic Relationship Builder. An example of a Dynamic Relationship Builder is depicted in FIG. 24 pre-populated with a set of Forms and their form types, and Name-Value pairs and their associated Compositions in the Form Classification Repository. The Dynamic Relationship Builder has two main components, the Relationship Mapper and the Relationship Calculator.

The Relationship Mapper performs a dual job: Maps the Name-Value pairs as Source and Target; Maps the given unknown form to the appropriate Form type and renders the Form type to the user thus accomplishing the task assigned to the Form Recognition Phase of the Form Recognizer Model.

The Form Classification Repository comprises of two different databases: the primary database and the secondary database. The primary database is referred to as the Form Classification Repository, which is initially populated, the Name-Values are marked as either a Source or Target. The relationship between the Source and Target in any form type is significant. These details when captured would add value to the upcoming Form Recognition phase of the Form Recognizer Model. The secondary database is the one used to store the set of all extracted information form the form that is fed for recognizing the form. This secondary database stores the Name-Value pairs, and the associated compositions fetched from the digitization phase and is rendered to the Form Recognition Phase. The data in the secondary database is compared with that in the Form Classification Repository (primary database) to fetch a matching entry.

The steps involved in the mapping the Name-Value pair as a Source or Target are given below:
1. Send all the identified entities such as the Name-Value pairs, Tables and INDEPENDENT values and their associated Compositions from the Form Recognition Phase to the Dynamic Relationship Builder.
2. Dynamic Relationship Builder checks for a mapping of the received entities with that already stored in the Form Classification Repository.
   a. If exact mapping found
      i. fetch the name of the form type and version number (if any) from the repository.
      ii. Render the above details to the user
   b. Else if, Name-Value pair alone matches but the Compositions are different (Repository Updated)
      i. Assign a new version number to this form in the repository.
      ii. Fetch the name of the form type from the repository.
      iii. Render the name of the form type and the new version number of it to the user.
   c. Else if, neither the Name-Value pair nor the Compositions matches (Repository Updated)
      i. The given form is a new classification
      ii. Stored the received form details a new entry in the repository with a new name for this form type.
      iii. Render the new details assigned to the form to the user
      iv. Give an alert message to the admin with an indication that a new form type is added
3. If the form type is already available in the repository (2a & 2b) then map the Name-Value pairs as Source/Target by executing the following steps:
a. If all the data in the Name-Value pair matches exactly with that in the repository, perform a direct mapping of the Source/Target label available in the repository to the respective Name-Value pairs of the input form.
b. If only a few of the Name-Value pair data matches, map all the matching Name-Value pairs as Source and the other set of Name-Value pair as Target. (This is done based on the logic that Source of the Form remains constant while the Target may vary for example, the Source of an ID card is the same organization, but the Target of the ID card (employees) will vary. Same applies to Voter ID, Driving License etc.).
c. Else if the from received is not available in the repository (2c), give an alert message to the admin that a new form is added to the repository which needs Source/Target mapping

The Relationship Calculator calculates the association of the Name-Value pairs with each of the form types as STRONG, MODERATE or WEAK. The Relationship Calculator implements a Standard Deviation (SD) calculation to plot all frequency of occurrence of the Name-Value pairs on each of the form types and Derived Varying Threshold values to map the level of association of the Name-Values pairs with the form types.

The “level of association” can be defined as a measure that quantifies the relevance or frequency of specific Name-Value pairs within a particular form type. This metric would indicate whether certain Name-Value pairs are highly characteristic (frequent and unique) of a form type or are more universally present across multiple form types.

Three different categories of such associations can be identified in forms. They are:
Strong Association: Name-Value pairs that are almost exclusively found in one form type and play a critical role in identifying that form. Name-Value pairs with strong association, when considered as a set, can be used to uniquely identify a form.
Moderate Association: Name-Value pairs that appear in multiple form types but still hold some unique context within certain forms. Name-Value pairs with moderate association contribute meaningfully to a form's functionality but are not exclusive to a single form type.
Weak Association: Name-Value pairs commonly found across a wide variety of forms with little relevance to a specific form type. Name-Value pairs with weak association are generic or ubiquitous.

The following are a few examples of forms and sets of Name-Value pairs that are strongly, moderately, and weakly associated with them.

### 1. Tax Form

Strongly associated Name-Value Pairs Set: “Taxpayer ID,” “Filing Status.”

Moderately associated Name-Value Pairs Set: “Address,” “Bank Account Number.”

Weakly associated Name-Value Pairs Set: “Date,” “Name.”

### 2. Medical Form

Strongly associated Name-Value Pairs Set: “Patient ID,” “Medical History.”

Moderately associated Name-Value Pairs Set: “Date of Birth,” “Phone Number.”

Weakly associated Name-Value Pairs Set: “Signature,” “Date.”

### 3. Educational Form

Strongly associated Name-Value Pairs Set: “Student ID,” “Degree Program.”

Moderately associated Name-Value Pairs Set: “Date of Birth,” “Parent/Guardian Contact.”

Weakly associated Name-Value Pairs Set: “Name,” “Date.”

### 4. Loan Application Form

Strongly associated Name-Value Pairs Set: “Loan Amount,” “Repayment Period.”

Moderately associated Name-Value Pairs Set: “Employment Status,” “Monthly Income.”

Weakly associated Name-Value Pairs Set: “Name,” “Date.”

The matching/mapping of the key value pairs in the set of strongly/moderately/weakly associated Name-Value pairs with the existing form types is detailed below.
1. Extract the Name-Value pairs in the given form for recognition.
2. Compare this Name-Value pair with each of the forms in the repository and check if it exists in the Strong, Moderate, or Weak set of any form type.
3. Create three sets for the new form:
   Strong Set: Extracted pairs found in the Strong association set of any form type.
   Moderate Set: Extracted pairs found in the Moderate association set of any form type.
   Weak Set: Extracted pairs found in the Weak association set of any form type.
4. For each form type in the repository that has a matching set of Name Value pairs, calculate a match score based on how many key-value pairs fall into Strong, Moderate, and Weak sets for that type:
   Score=ws×Strong Matches+wm×Moderate Matches+ww×Weak Matches where ws, wm, ww are weights (e.g., ws=5, wm=3, ww=1).

The form type with the highest match score is assigned to the new form. For example, let us have two forms in the repository:

### Loan Forms:

Strong: {“Loan Amount,” “Repayment Period,” “Collateral Type”}

Moderate: {“Employment Status,” “Monthly Income”}

Weak: {“Name,” “Date”}

### Invoices:

Strong: {“Invoice Number,” “Billing Address,” “Total Amount Due”}

Moderate: {“Payment Terms,” “Purchase Order Number”}

Weak: {“Name,” “Date”}

Extracted Name-Value pairs in the new form to be recognized are {“Name,” “Loan Amount,” “Monthly Income,” “Repayment Period,” “Date”}

Now let us match against the repository using ws=5, wm=3, ww=1:

### 1. Loan Forms:

Strong Matches: {“Loan Amount,” “Repayment Period”}=2×ws=10

Moderate Matches: {“Monthly Income”} =1×wm=3

Weak Matches: {“Name,” “Date”} =2×ww=2

Total Score: 10+3+2=15

### 2. Invoices:

Strong Matches: None=0×ws=0

Moderate Matches: None=0×wm=0

Weak Matches: {“Name,” “Date”}=2×ww=2

Total Score: 0+0+2=2

Classification: The highest score is 15 that matches with the Loan Forms. Hence this new form is classified as a Loan Form.

The Relationship Calculator calculates the level of association of each of the Name value pairs to the form types.

The steps involved in the Relationship Calculator are given below.

Data Collection: The number of forms of each form type is recorded and the frequency of the Name-Value pairs in each of the form types is calculated. The process is repeated for all the Name-Value pairs in each of the form types fed to the Form Recognizer Model.

Dynamic Calculation of Moving Mean: Convert the frequencies into percentage and now the mean, more specifically called the MOVING MEAN, the variance, and the standard deviation of the frequency (in terms of percentage) of the Name-Value pairs in each of the form types are calculated. The MOVING MEAN is named so since, this mean will change dynamically. This is because, whenever new forms of the same or different form types are dynamically loaded into the system for recognition, the frequency of occurrence of the Name-Value pairs are recalculated and any change in the frequency is automatically reflected in the MOVING MEAN and thus carried over to the variance and the standard deviation of the form types.

Definition of Derived Varying Thresholds: Thresholds that are a function of the standard deviation bands chosen and used to associate the Name-Value pairs as STRONG/MODERATE/WEAK with respect to each of the form types.

1. Name-Value pairs within a function of the +/−1 SD: Most of the data points lie within this range, indicating a common or expected behavior and hence these Name-Value pairs are STRONGLY associated with the form type.

2. Name-Value pairs between a function of the +/−1 and +/−2 SD: These data points are less frequent but still fall within an acceptable range and hence these Name-Value pairs are MODERATELY associated with the form type.

3. Name-Value pairs beyond a function of the +/−2 SD: Data points outside this range are uncommon and may signify anomalies, outliers, or significant deviations from the expected behavior and hence these Name-Value pairs are WEAKLY associated with the form type.

Though the thresholds chosen here are a function of the fixed standard deviation bands, the MOVING MEAN redefines the Name-Value pairs that would fall into these threshold bands and hence the thresholds we define are Derived Varying Thresholds.

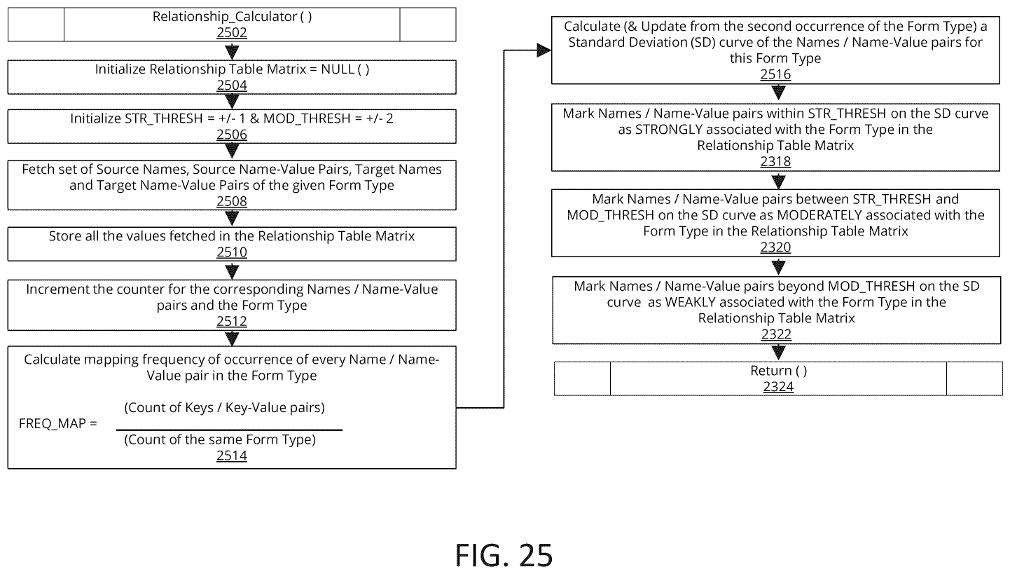

Once the Form Classification Repository is populated with the Name-Value pairs, the form type and the association of the Name-Value pair with the form types, the Dynamic Relationship Builder is ready to support the Form Design Recommendation Phase. Steps involved in the Relationship Calculator are shown in FIG. 25 by way of example. In this example, to start, Relationship_Calculator (2502) initializes Relationship Table Matrix to NULL (2504) and STR_THRESH to +/−1 and MOD_THRESH to +/−2 (2506). The flowchart proceeds with fetching set of Source Names, Source Name-Value pairs, Target Names, and Target Name-Value pairs of a given Form type (2508), storing the fetched values in the Relationship Table Matrix (2510), and incrementing the counter for the corresponding Names and Name-Value pairs and the Form type (2512). Mapping frequency of occurrence of every Name and Name-Value pair in the form type (2514) can be accomplished with the formula FREQ_MAP=(Count of Names and Name-Value pairs)/Count of the same Form type). A Standard Deviation (SD) curve of Names and Name-Value pairs for the Form type is calculated and updated from the second occurrence of the Form type (2516). Names and Name-Value pairs within STR_THRESH on the SD curve are marked as STRONGLY associated with the Form type in the Relationship Table Matrix (2518). Names and Name-Value pairs between STR_THRESH and MOD_THRESH on the SD curve are marked as MODERATELY associated with the Form type in the Relationship Table Matrix (2520). Names and Name-Value pairs beyond MOD_THRESH on the SD curve are marked as WEAKLY associated with the Form type in the Relationship Table Matrix (2522).

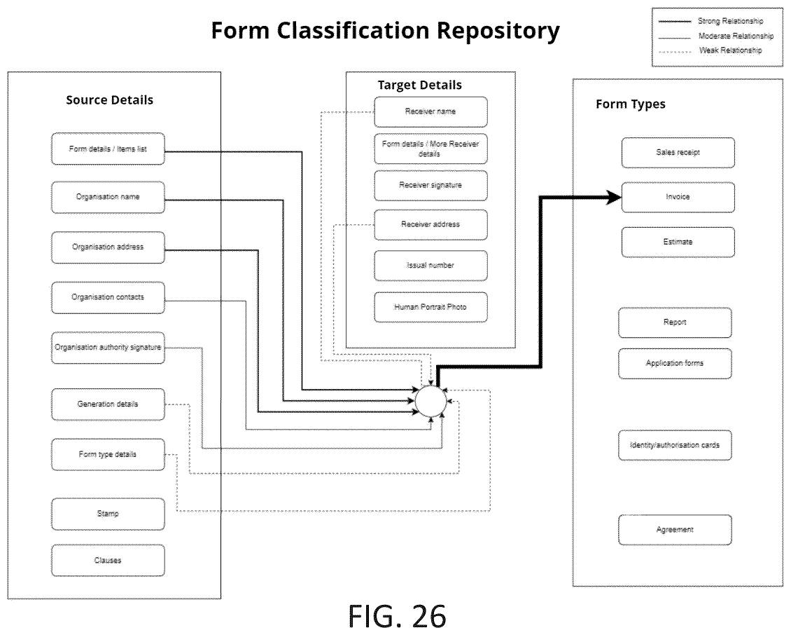

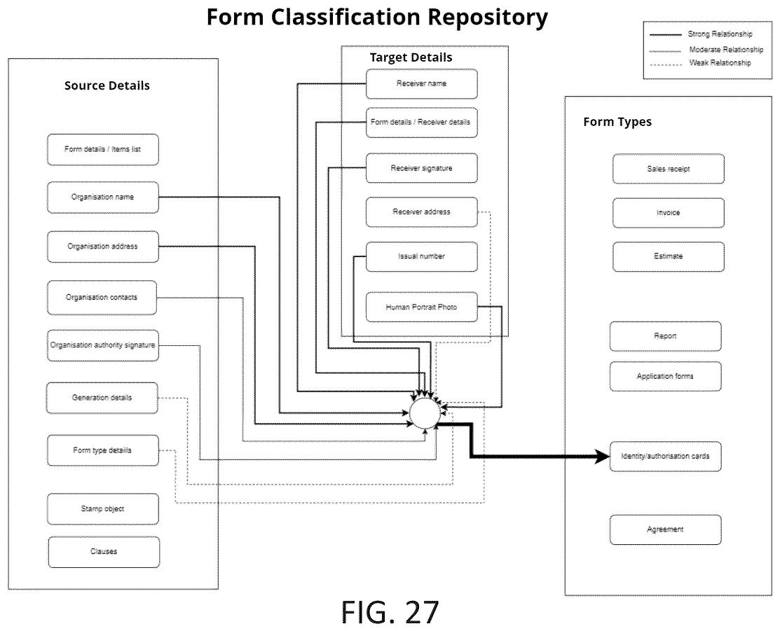

As just described, the Dynamic Relationship Builder tries to associate each of the Name-Value pairs labeled as Source/Target as Strongly, Moderately, or Weakly associated with the Form Types with the help of the Relationship Calculator. FIGS. 26 and 27 show such mapping of Source & Target Name-Value pairs as Strongly, Moderately, or Weakly related to a specific set of Form Types.

The Form Recognizer Model acts as a recommendation system for any form that is to be designed. Here the name of the Form type to be designed is given as Input to the Form Recognizer Model. The Dynamic Relationship Builder supports the Form Design Recommendation phase.

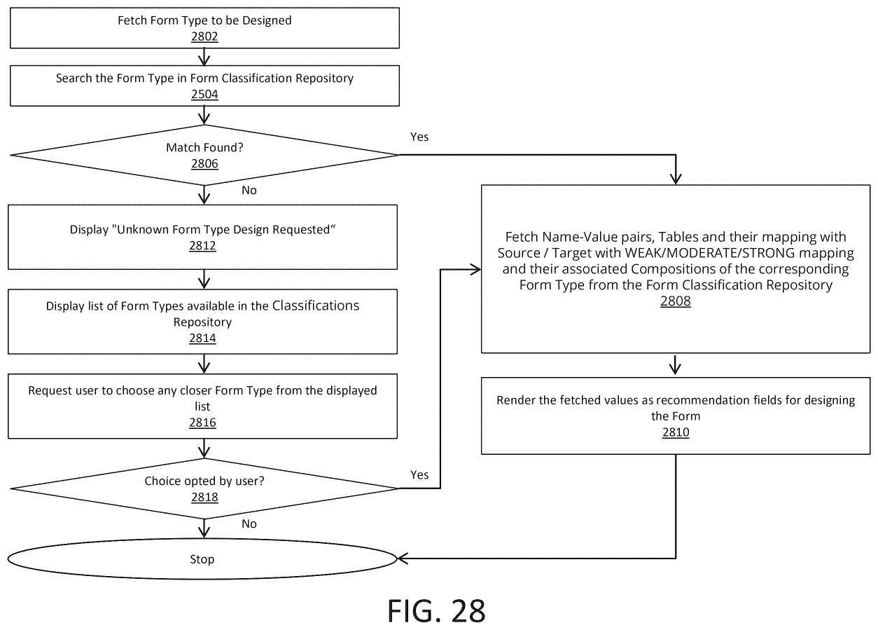

FIG. 28 depicts an example of a process flow that gives a recommendation for a new form design. The name of the Form type is given to the Dynamic Relationship Builder (2802) and the Dynamic Relationship Builder verifies (2804) the same in the Form Classification Repository for a matching entry (2806). If a match is available (2806—Yes) then, the Name-Value pairs, Tables, their Source/Target labels and their associated Compositions along with the weightage of relationship of the Name-Value pairs with the Form type in terms of WEAK/MODERATE/STRONG are fetched (2808) and rendered (2810) to the user as a suggestion list. These entities are displayed as a form template to the user. But if the Form type is not present in the repository (2806—No), then the Recommendation Module displays “Unknown Form Type Design Requested” (2812) and the available Form types rendered to the user (2814) so the user can find a closer form type to choose (2816) and the flowchart continues to module 2808 as described previously, where corresponding entries are suggested. If the user does not choose any from the displayed list, the execution halts.

As a use case, consider a business that uses multiple forms for its day-to-day processing and depending on the increasing and changing demands of the business model, new forms are generated and new versions of the old forms in use are also generated. When a new version of an old form is required, the old form is fed to the proposed Form Recognizer Model which scans the form, extracts digital contents, recognizes the type of the form, and gives suggestion for a new version of the form that can be designed in future. It is not mandatory to give the name/type of the form during this process because the proposed model can automatically detect the form type. The recommendation phase may be to include new Names or to remove some of the existing Names to create a next better version of the old form fed to this system.

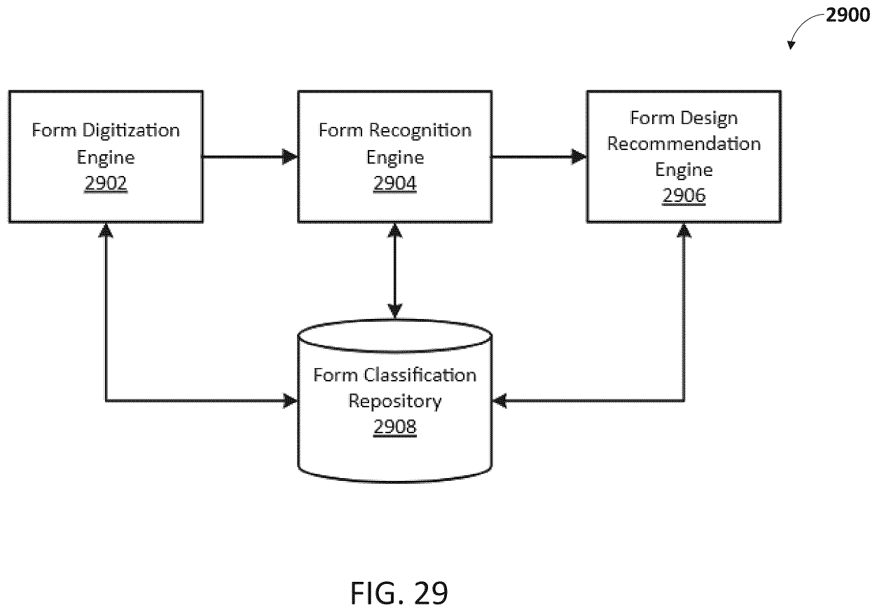

FIG. 29 is a diagram 2900 of an example of a Form Recognition System. The diagram 2900 includes a form digitization engine 2902, a form recognition engine 2904, a form design recommendation engine 2906, and a form classification repository 2908.

The system described in association with FIG. 29, and other descriptions in this paper, makes use of a network to couple components of the system. The network and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The network and other computer readable mediums discussed in this paper are intended to represent a variety of potentially applicable technologies. For example, the network can be used to form a network or part of a network. Where two components are co-located on a device, the network can include a bus or other data conduit or plane. Where a first component is co-located on one device and a second component is located on a different device, the network can include or encompass a relevant portion of a wireless or wired back-end network or Local Area Network (LAN). The network can also encompass a relevant portion of a Wide Area Network (WAN) or other network, if applicable.

The devices, systems, and computer-readable mediums described in this paper can be implemented as a computer system or parts of a computer system or a plurality of computer systems. As used in this paper, a server is a device or a collection of devices. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor that is a component of the engine. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

A database management system (DBMS) can be used to manage a datastore. In such a case, the DBMS may be thought of as part of the datastore, as part of a server, and/or as a separate system. A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines. Engines and datastore modules can be present in a monolithic system (as a single application) or can be designed as microservices deployed on the cloud.

The form digitization engine 2902 is intended to represent an engine responsible for digitizing a form as described with reference to FIGS. 5-13. The form recognition engine 2904 is intended to represent an engine responsible for recognizing a form as described with reference to FIGS. 14-27. The form design recommendation engine 2906 is intended to represent an engine responsible for recommending a form as described with reference to FIG. 28. The form classification repository 2908 provides volatile and/or non-volatile storage for data that is used by all three of the engines.

What is claimed is:

1. A method comprising:
clustering text elements of a scanned form into a plurality of compositions using visual density clustering;
extracting the text elements as a plurality of individual items using relative gap analysis, wherein the individual items are identifiable by the relative gap analysis;
mapping the plurality of individual items to the plurality of compositions based on spatial nearness to a centroid of the plurality of compositions;
extracting individual cell values from the plurality of individual items using cell correction;
identifying name-value pairs of the individual cell values.

2. The method of claim 1, comprising:
grouping the individual items based on nearness in proximity into different compositions, wherein each of the different compositions is assigned a respective unique identifier;
associating individual items within the different compositions with the respective unique identifiers.

3. The method of claim 1, comprising:
analyzing the plurality of individual items for cell correction using separator analysis;
when a cell comprises a single separator, splitting cell contents into a first part that includes the single separator and data before the single separator, and a second part that includes data after the single separator;
storing the first part in a first cell and the second part in a second adjacent cell.

4. The method of claim 1, comprising:
analyzing the plurality of individual items for cell correction using separator analysis;
when a cell comprises more than one separator, storing data of the cell in a single cell, wherein the data maps to a date or time format.

5. The method of claim 1, comprising identifying the individual cell values as a value selected from a group consisting of explicit name, explicit name value, implicit value, and independent value.

6. The method of claim 1, comprising identifying explicit names and associated values within the individual items by comparing with an explicit name repository.

7. The method of claim 1, comprising using a decide progression process to identify values present in a same column or row of a table that are associated with a single name.

8. The method of claim 1, comprising using a union behavior verification process to identify a table with columns or rows in adjacent compositions.

9. The method of claim 1, comprising generating an implicit name instance comprising a set of values based on a factor selected from a group of factors consisting of: existence of the individual cell values, a possible number of variables present in the individual cell values, variable sequencing of the individual cell values, order of the individual cell values, positioning of the individual cell values, proximity of the individual cell values, and a combination of these.

10. The method of claim 1, comprising generating a repository of implicit names.

11. The method of claim 1, comprising:
comparing existence and variable type within an implicit name repository;
identifying, from the comparison, implicit names for values within the individual cells.

12. The method of claim 1, comprising using a decide progression process to identify multiple values of a similar type associated with an implicit name.

13. The method of claim 1, comprising using a union behavior verification process to identify columns and rows associated with a table but present in adjacent compositions.

14. The method of claim 1, comprising using whole form analysis to identify values that do not fall into explicit or implicit names and associating the values with those in neighboring compositions.

15. The method of claim 1, comprising labeling values that could not be mapped into independent values.

16. The method of claim 1, wherein the relative gap analysis is based on mode gap in the scanned form, wherein mode gap is a maximum gap between any two of the text elements of the scanned form.

17. The method of claim 1, comprising:
identifying tables spanning the plurality of compositions using union behavior verification of the plurality of individual items;
rendering extracted contents in an editable format;
storing the editable format of the scanned form.

18. A system comprising a processor and memory, the memory including instructions that, when executed by the processor, cause the system to perform:
clustering text elements of a scanned form into a plurality of compositions using visual density clustering;
extracting the text elements as a plurality individual items using relative gap analysis, wherein the individual items are identifiable by the relative gap analysis;
mapping the plurality of individual items to the plurality of compositions based on spatial nearness to a centroid of the plurality of compositions;
extracting individual cell values from the plurality of individual items using cell correction;
identifying name-value pairs of the individual cell values.

19. The system of claim 18, comprising a form digitization engine that stores an editable format of the scanned form in a form classification repository.

20. The system of claim 19, comprising a form recognition engine that accesses the form classification repository.

21. The system of claim 19, comprising a form design recommendation engine that accesses the form classification repository.

22. The system of claim 18, wherein the relative gap analysis is based on mode gap in the scanned form, wherein mode gap is a maximum gap between any two of the text elements of the scanned form.

23. The system of claim 18, the memory including instructions that, when executed by the processor, cause the system to perform:
identifying tables spanning the plurality of compositions using union behavior verification of the plurality of individual items;
rendering extracted contents in an editable format;
storing the editable format of the scanned form.

24. A system comprising:
a means for clustering text elements of a scanned form into a plurality of compositions using visual density clustering;
a means for extracting the text elements as a plurality individual items using relative gap analysis, wherein the individual items are identifiable by the relative gap analysis;
a means for mapping the plurality of individual items to the plurality of compositions based on spatial nearness to a centroid of the plurality of compositions;
a means for extracting individual cell values from the plurality of individual items using cell correction;
a means for identifying name-value pairs of the individual cell values.
